(19) United States
(12) Patent Application Publication
(10) Pub. No.: US 2025/0362941 A1
(43) Pub. Date: Nov. 27, 2025

(54) GENERATING HOW-TO GUIDES GROUNDED IN ELEMENTS OF IN-USE USER INTERFACES VIA VIRTUAL ASSISTANTS

(71) Applicant: Adobe Inc., San Jose, CA (US)

(72) Inventors: Victor Soares Bursztyn, Mountain View, CA (US); Minsoo Kim, Seoul (KR); Shunan Guo, San Jose, CA (US); Eunyee Koh, Sunnyvale, CA (US)

(21) Appl. No.: 18/670,398

(22) Filed: May 21, 2024

(51) Int. Cl. G06F 9/451; G06F 16/9538; G06F 16/957; G06F 40/20

(52) U.S. Cl. CPC G06F 9/453; G06F 16/9538; G06F 16/9577; G06F 40/20

(57) ABSTRACT

The present disclosure relates to systems, methods, and non-transitory computer-readable media that generate instructions for performing a next action of a task. For instance, in some cases, the disclosed systems receive, from a client device interacting with a software application, a query for performing a task via a user interface of the application. The disclosed systems generate a lookahead prompt having an execution example corresponding to the task, the execution example including an example task and an example action sequence for the example task. The disclosed systems also generate, from the lookahead prompt using a large language model, an estimated lookahead plan describing one or more actions for performing the task. The disclosed systems also use one or more large language models to generate, from the estimated lookahead plan, instructions to perform a next action for the task via user interaction with an interactive element of the user interface.

### BACKGROUND

Recent years have seen significant advancement in hardware and software platforms that facilitate user engagement with software features and tools through corresponding user interfaces. In particular, as software applications have become increasingly powerful and complex, systems have developed to improve the effectiveness of their corresponding user interfaces (UIs). For instance, some conventional systems implement a virtual assistant that assists a user in performing a task in a software application, such as by providing instructions on how to engage with the corresponding UI to execute the required steps for the task. Despite these advancements, conventional UI virtual assistant systems fail to flexibly adapt to the UI being used, often leading to the provision of instructions that are irrelevant to that user interface.

### SUMMARY

One or more embodiments described herein provide benefits and/or solve one or more of the foregoing or other problems in the art with systems, methods, and non-transitory computer-readable media that use large language models to flexibly ground virtual assistant instructions in relevant user interface (UI) elements. To illustrate, in one or more embodiments, the disclosed systems use a large language model to generate a lookahead plan that estimates the actions to be executed via a UI in performance of a task. In some cases, the disclosed systems further use one or more large language models to incorporate chain-of-thought reasoning and/or cooperative reasoning in predicting a next action to be executed (e.g., an operation to be executed and a UI element to be targeted by the operation). Thus, in some embodiments, the disclosed systems receive a query requesting assistance in performing a task via a UI and use the large language model(s) to generate instructions for performing a next action in response to the query. In this manner, the disclosed systems flexibly adapt the instructions to the UI, allowing for a more relevant query response based on corresponding UI elements.

Additional features and advantages of one or more embodiments of the present disclosure are outlined in the following description.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a UI-grounded action prediction system operates in accordance with one or more embodiments;

FIG. 2 illustrates an overview diagram of the UI-grounded action prediction system 106 generating instructions for performing a next action in performance of a task in accordance with one or more embodiments;

FIGS. 3A-3C illustrates the UI-grounded action prediction system responding to a query by generating and providing instructions for performing a task via a user interface in accordance with one or more embodiments;

FIG. 4 illustrates the UI-grounded action prediction system selecting one or more execution examples for inclusion within a lookahead prompt in accordance with one or more embodiments;

FIG. 5 illustrates a lookahead prompt in accordance with one or more embodiments;

FIGS. 6A-6E illustrate a target element prompt in accordance with one or more embodiments;

FIG. 7 illustrates an example schematic diagram of a text-to-image editing system in accordance with one or more embodiments;

FIG. 8 illustrates a flowchart of a series of acts for generating instructions for a performing a next action of a text described by a query in accordance with one or more embodiments; and

FIG. 9 illustrates a block diagram of an exemplary computing device in accordance with one or more embodiments.

### DETAILED DESCRIPTION

One or more embodiments described herein include a UI-grounded action prediction system that uses one or more large language models to ground virtual assistant instructions in appropriate user interface (UI) elements for creating how-to guides on the fly in response to user queries. In particular, in some embodiments, the UI-grounded action prediction system uses the large language model(s) to incorporate lookahead plan generation, chain-of-thought reasoning, and/or cooperative reasoning into an action prediction process. To illustrate, in some cases, the UI-grounded action prediction system uses a large language model to generate an estimated lookahead plan for completing a task described by a query and uses one or more additional large language models to predict an operation and a target UI element for a next action for the task. In some cases, the UI-grounded action prediction system performs target element prediction using a prompt having chain-of-thought reasoning that decomposes the step into reasoning about the operation type and choosing an appropriate UI element. In some embodiments, the UI-grounded action prediction system performs the action prediction process with respect to a set of candidate elements from the UI being used, enabling selection of a relevant target element.

To illustrate, in one or more embodiments, the UI-grounded action prediction system receives, from a client device interacting with a software application, a query for performing a task via a user interface of the software application. The UI-grounded action prediction system generates a lookahead prompt comprising at least one execution example corresponding to the task, the at least one execution example including an example task and an example action sequence for performing the example task. From the lookahead prompt, the UI-grounded action prediction system uses a large language model to generate an estimated lookahead plan describing one or more actions for performing the task. Further, the UI-grounded action prediction system generates, from the estimated lookahead plan using one or more large language models, instructions to perform a next action in a sequence for performing the task via user interaction with an interactive element of the user interface.

As just indicated, in one or more embodiments, the UI-grounded action prediction system generates a next action for performing a task in response to a query. In particular, in some embodiments, the UI-grounded action prediction system receives a query for performing a task via a UI of a software application (e.g., an image editing application or a data analytics application). The UI-grounded action prediction system generates instructions to perform a next action for the task via the UI in response to the query. Indeed, in some instances, the UI-grounded action prediction system grounds the instructions for the next action in the UI itself (e.g., in the interactive elements of the UI) to provide relevant instructions.

In some embodiments, the UI-grounded action prediction system generates the instructions through a multi-step process. For instance, in some cases, the UI-grounded action prediction system performs a candidate generation step and an action prediction step.

In certain embodiments, the UI-grounded action prediction system performs the candidate generation step by generating a set of candidate interactive elements to consider for the next action of the task. To illustrate, in certain cases, the UI-grounded action prediction system extracts interactive elements from an environment representation (e.g., a hypertext markup language representation) of the UI. The UI-grounded action prediction system further ranks the interactive elements using a ranking model and determines the set of candidate interactive elements based on the ranking (e.g., by selecting the top-n ranked interactive elements).

In one or more embodiments, the UI-grounded action prediction system performs the action prediction step by determining the next action to be performed for the task. As mentioned, in some cases, the UI-grounded action prediction system performs the action prediction step using lookahead plan generation, chain-of-thought reasoning, and/or cooperative reasoning. As further mentioned, in certain implementations, the UI-grounded action prediction system uses one or more large language models for the action prediction step.

To illustrate, in some embodiments, the UI-grounded action prediction system uses a large language model to generate an estimated lookahead plan for the task. In some embodiments, the estimated lookahead plan describes one or more actions for performing the task. In some cases, one or more previous actions have already been executed and the estimated lookahead plan describes the remaining actions for the task.

Additionally, in some cases, the UI-grounded action prediction system uses one large language model to generate an operation for the next action and uses another large language model to generate an interactive element to be targeted by the operation. In particular, in certain embodiments, the UI-grounded action prediction system generates the operation and the interactive element separately and uses the determined operation in determining the targeted interactive element via cooperative reasoning. Further, in some embodiments, the UI-grounded action prediction system determines the targeted interactive element from the set of candidate interactive elements determined via candidate generation.

In some embodiments, the UI-grounded action prediction system uses the estimated lookahead plan in determining the targeted interactive element. In some instances, the UI-grounded action prediction system further uses chain-of-thought reasoning in determining the targeted interactive element. For instance, in some cases, the UI-grounded action prediction system provides, to the large language model, a prompt that conditions the large language model to reason about the determined operation and select an appropriate (e.g., compatible) interactive element.

As mentioned, in some cases, the UI-grounded action prediction system generates instructions for the next action. For instance, in some cases, the UI-grounded action prediction system generates a natural language response to the query indicating the operation to perform and the interactive element to target. In certain embodiments, the UI-grounded action prediction system provides the instructions for display on the client device that submitted the query.

As mentioned above, conventional UI virtual assistant systems suffer from several technological shortcomings that result in inflexible, inaccurate, and inefficient operation. For instance, many conventional systems are inflexible in that they fail to adapt to the UI that is currently in use when generating instructions for performing a task on that UI. Indeed, many conventional systems use stored documentation and/or prior training to generate instructions in response to queries; however, such systems often fail to recognize the UI from which they are being called and fail to ground their instructions in the correct UI elements as a result. In particular, rather than responding to queries using elements of the current UI, such systems tend to hallucinate elements that do not exist in the UI and incorporate those elements into their responses. For example, conventional systems often generate responses based on documentation that corresponds to an outdated UI or documentation that is otherwise unrelated (e.g., obtained via an unsuccessful retrieval), based on a different UI that enables the same task, based on old UIs memorized during training, and/or based on a conflation of multiple UIs seen during training. Some conventional systems do attempt to ground generated instructions in the elements of the current UI but are poor at selecting the correct UI element to include. For instance, some systems generate a predicted operation and predicted element for the operation together. While some of these systems perform well in predicting the operation, they often fail to predict the correct UI element, leading to instructions that incorporate the wrong element.

Additionally, conventional UI virtual assistant systems often fail to operate accurately. In particular, conventional systems often generate query responses that provide inaccurate instructions for performing a task on the UI that is currently in use. Indeed, by failing to adapt to the current UI and by hallucinating non-existent elements for that UI, conventional systems typically generate query responses that provide instructions for performing a task on a different UI or on a non-existent UI. Thus, these systems fail to accurately respond to queries for performing a task on the UI currently being used.

In addition to problems of inflexibility and inaccuracy, conventional UI virtual assistant systems also experience problems of efficiency. In particular, conventional systems often fail to efficiently guide a user through the process of performing a task on a UI. In particular, by failing to adapt to the UI currently in use and by providing inaccurate instructions for performing a task on that UI, conventional systems tend to require a significant amount of user interactions with the UI to perform the task. For instance, clearly inaccurate instructions (e.g., instructions indicating a top-level menu option that is not present) often lead to blind navigation through the UI and its multiple windows, menus, and/or sub-menus—often as if the instructions were never provided to begin with. Alternatively, misleading instructions (e.g., instructions based on a UI with similar to-level menus but different sub-menus) sometimes misdirect navigation efforts, causing a user to interact with the UI more than would have occurred had the instructions never been provided.

One or more embodiments of the UI-grounded action prediction system provide several advantages over conventional systems. For example, one or more embodiments of the UI-grounded action prediction system improve the flexibility of implementing computing devices when compared to conventional systems. In particular, by generating an estimated lookahead plan and/or by incorporating chain-of-thought reasoning and/or cooperative reasoning in the action prediction process, embodiments of the UI-grounded action prediction system more flexibly adapt generated instructions into the elements of the UI currently being used. Further, by separately determining an operation and a target interactive element using chain-of-thought reasoning and/or cooperative reasoning, one or more embodiments of the UI-grounded action prediction system improve selection of the correct interactive element, enabling the resulting instructions to be appropriately grounded within the current UI.

Additionally, one or more embodiments of the UI-grounded action prediction system improve the accuracy of implementing computing devices when compared to conventional systems. In particular, one or more embodiments of the UI-grounded action prediction system provide instructions that more accurately guide a user through performing a task via the UI that is currently being used. Indeed, by using methods that lead to the improved grounding of instructions in the current UI, embodiments of the UI-grounded action prediction system generate instructions that are more accurately tied to that UI.

Further, one or more embodiments of the UI-grounded action prediction system improve the efficiency of implementing computing devices when compared to conventional systems. In particular, embodiments of the UI-grounded action prediction system reduce the number of user interactions required to complete a task on a UI when compared to many conventional systems. Indeed, by adapting to the UI being used and providing instructions that accurately incorporate elements of the UI, one or more embodiments of the UI-grounded action prediction system provide instructions that enable a user to perform a task using fewer interactions.

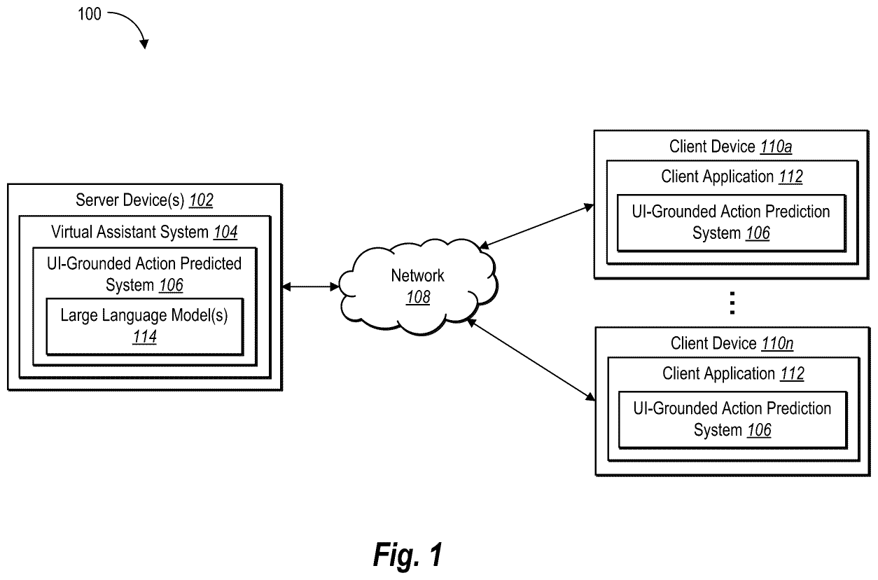

Additional details regarding the UI-grounded action prediction system will now be provided with reference to the figures. For example, FIG. 1 illustrates a schematic diagram of an exemplary system environment (“environment”) 100 in which a UI-grounded action prediction system 106 operates. As illustrated in FIG. 1, the environment 100 includes a server device(s) 102, a network 108, and client devices 110a-110n.

Although the environment 100 of FIG. 1 is depicted as having a particular number of components, the environment 100 is capable of having any number of additional or alternative components (e.g., any number of server devices, client devices, or other components in communication with the UI-grounded action prediction system 106 via the network 108). Similarly, although FIG. 1 illustrates a particular arrangement of the server device(s) 102, the network 108, and the client devices 110a-110n, various additional arrangements are possible.

The server device(s) 102, the network 108, and the client devices 110a-110n are communicatively coupled with each other either directly or indirectly (e.g., through the network 108 discussed in greater detail below in relation to FIG. 9). Moreover, the server device(s) 102 and the client devices 110a-110n include one of a variety of computing devices (including one or more computing devices as discussed in greater detail with relation to FIG. 9).

As mentioned above, the environment 100 includes the server device(s) 102. In one or more embodiments, the server device(s) 102 generates, stores, receives, and/or transmits data including responses to queries having instructions for performing a task on a UI. In one or more embodiments, the server device(s) 102 comprises a data server. In some implementations, the server device(s) 102 comprises a communication server or a web-hosting server.

In one or more embodiments, the virtual assistant system 104 provides functionality for interacting with a client device (e.g., a user of one of the client devices 110a-110n). For instance, in some cases, a client device submits a query, such as a request for information. The virtual assistant system 104 retrieves the requested information and responds to the query. For instance, in some cases the virtual assistant system generates a natural language response that directly provides the retrieved information, summarizes the retrieved information, or generates other information based on the retrieved information. In some cases, the virtual assistant system 104 provides queries responses via text and/or audio presentation.

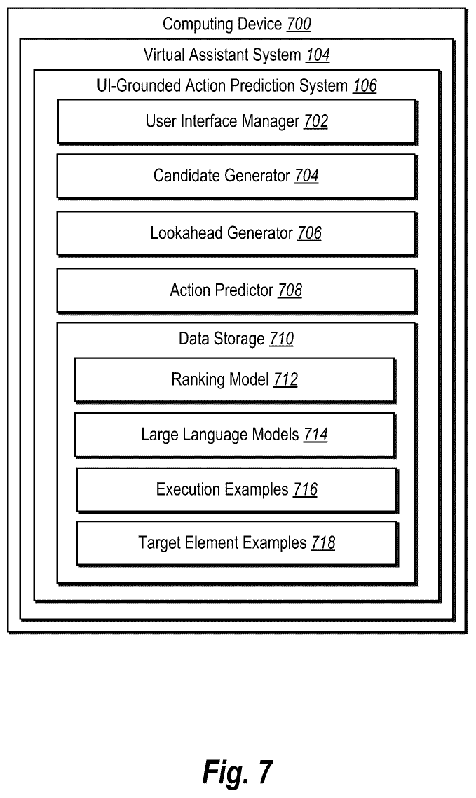

Additionally, the server device(s) 102 include the UI-grounded action prediction system 106. In one or more embodiments, via the server device(s) 102, the UI-grounded action prediction system 106 responds to queries for performing tasks by generating instructions that are grounded in the UIs of the software applications being used. In particular, in some cases, the UI-grounded action prediction system 106, via the server device(s) 102, responds to a query for performing a task via a UI of a software application by generating instructions for performing a next action via user interaction with an interactive element of the UI. In one or more embodiments, the UI-grounded action prediction system 106 generates the instructions via the server device(s) 102 using lookahead plan generation, chain-of-thought reasoning, and/or cooperative reasoning. Example components of the UI-grounded action prediction system 106 will be described below with regard to FIG. 7.

In one or more embodiments, the client devices 110a-110n include computing devices that that are capable of submitting queries, receiving query responses, and interacting with user interfaces. For example, in some embodiments, the client devices 110a-110n include smartphones, tablets, desktop computers, laptop computers, head-mounted-display devices, or other electronic devices. In some instances, the client devices 110a-110n include one or more applications (e.g., the client application 112) that are capable of submitting queries, receiving query responses, and interacting with user interfaces. For example, in some embodiments, the client application 112 includes a software application installed on the client devices 110a-110n. In other cases, however, the client application 112 includes a web browser or other application that accesses a software application hosted on the server device(s) 102.

One or more embodiments of the UI-grounded action prediction system 106 are implemented in whole, or in part, by the individual elements of the environment 100. Indeed, as shown in FIG. 1, one or more embodiments of the UI-grounded action prediction system 106 are implemented with regard to the server device(s) 102 and/or at the client devices 110a-110n. In particular embodiments, the UI-grounded action prediction system 106 on the client devices 110a-110n comprises a web application, a native application installed on the client devices 110a-110n (e.g., a mobile application, a desktop application, a plug-in application, etc.), or a cloud-based application where part of the functionality is performed by the server device(s) 102.

In additional or alternative embodiments, the UI-grounded action prediction system 106 on the client devices 110a-110n represents and/or provides the same or similar functionality as described herein in connection with the UI-grounded action prediction system 106 on the server device(s) 102. In some implementations, the UI-grounded action prediction system 106 on the server device(s) 102 supports the UI-grounded action prediction system 106 on the client devices 110a-110n.

For example, in some embodiments, the UI-grounded action prediction system 106 on the server device(s) 102 trains one or more machine learning models described herein (e.g., the large language model(s) 114). The UI-grounded action prediction system 106 on the server device(s) 102 provides the one or more trained machine learning models to the UI-grounded action prediction system 106 on the client devices 110a-110n for implementation. Accordingly, although not illustrated, in one or more embodiments, the UI-grounded action prediction system 106 on the client devices 110a-110n uses the one or more trained machine learning models to generate layouts from image elements independent from the server device(s) 102.

In some embodiments, the UI-grounded action prediction system 106 includes a web hosting application that allows the client devices 110a-110n to interact with content and services hosted on the server device(s) 102. To illustrate, in one or more implementations, the client devices 110a-110n accesses a web page or computing application supported by the server device(s) 102. The client devices 110a-110n provide input to the server device(s) 102, such as a query for performing a task via a user interface of a software application. In response, the UI-grounded action prediction system 106 on the server device(s) 102 utilizes the provided input to generate a response having instructions for performing a next action. The server device(s) 102 then provides the response to the query to the client devices 110a-110n.

In some embodiments, though not illustrated in FIG. 1, the environment 100 has a different arrangement of components and/or has a different number or set of components altogether. For example, in certain embodiments, the client devices 110a-110n communicate directly with the server device(s) 102 bypassing the network 108. As another example, the environment 100 includes a third-party server device comprising a content server and/or a data collection server.

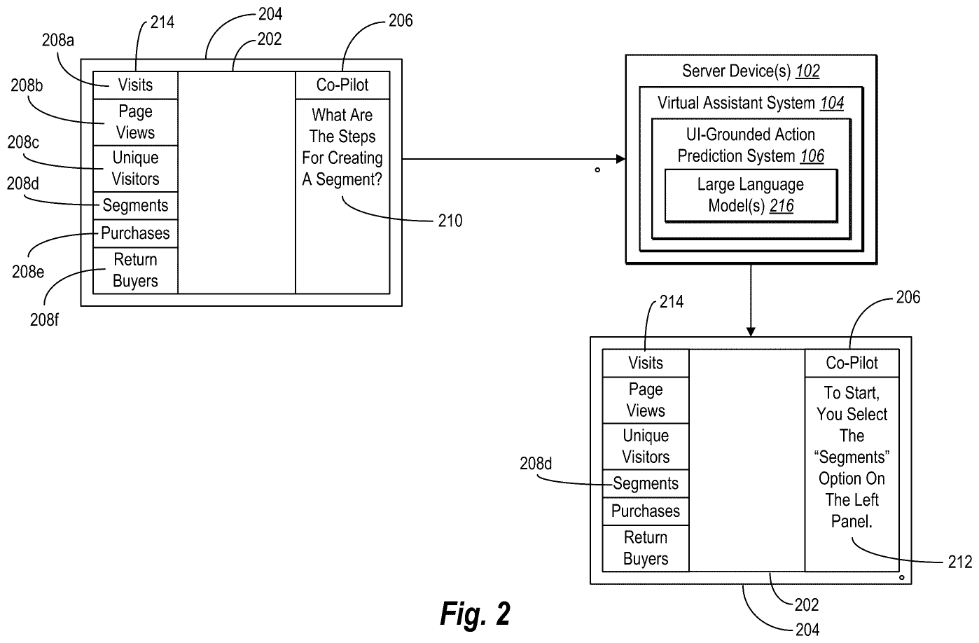

As mentioned, in one or more embodiments, the UI-grounded action prediction system 106 response to a query for performing a task on a UI of a software application by generating instructions for performing a next action via the UI. FIG. 2 illustrates an overview diagram of the UI-grounded action prediction system 106 generating instructions for performing a next action in performance of a task in accordance with one or more embodiments.

As shown in FIG. 2, the UI-grounded action prediction system 106 provides a user interface (UI) 202 of a software application for display on a client device 204. The UI-grounded action prediction system 106 provides, within the UI 202, a panel 214 of interactive elements 208a-208f. FIG. 2 shows a specific set of interactive elements within the panel 214, but it should be understood that the UI-grounded action prediction system 106 provides various interactive elements in different combinations in various embodiments.

In one or more embodiments, an interactive element includes an element of a UI (e.g., a graphical element of a graphical user interface) that receives user input via one or more user interactions with the interactive element. In some cases, the UI-grounded action prediction system 106 uses an interactive element to collect data, such as data entered via the user input. In some instances, an interactive element reacts or causes a reaction to a user interaction. For instance, in some embodiments, the UI-grounded action prediction system 106 changes an appearance of the UI or performs some other action(s) upon detecting a user interaction with an interactive element. In some implementations an interactive element includes a button, a menu (e.g., a drop-down menu), a link or hyperlink, an interactive image or map, or a text field.

Additionally, as shown, the UI-grounded action prediction system 106 provides, within the UI 202, a panel 206 for interacting with a virtual assistant. In particular, the UI-grounded action prediction system 106 provides the panel 206 to enable the submission of queries and/or the provision of query responses. For instance, as illustrated, the UI-grounded action prediction system 106 provides a query 210 received from a client device for display within the panel 206. The query 210 requests assistance in using the software application (e.g., the UI 202) to perform a specified task (i.e., creating a segment). In particular, the query 210 requests instructions on which actions are needed to perform the specified task using the UI 202.

In one or more embodiments, a task includes an undertaking to be performed. In particular, in some embodiments, a task includes a cohesive unit of work to be performed to achieve a particular goal. In some cases, as indicated by FIG. 2, a task is performed using a software application (e.g., using the tools and features offered by the software application). As such, in certain cases, different software applications enable the performance of different tasks. As more particularly shown in FIG. 2, in some instances, a task is performed using a UI of the software application. For instance, in some implementations, a task is performed via user interaction with one or more interactive elements available through the UI of the software application.

The UI 202 shown in FIG. 2 corresponds to an analytics application. Indeed, as shown, the interactive elements 208a-208f include interactive elements related to data analytics. It should be understood, however, that various implementations of the UI-grounded action prediction system 106 provide UIs that correspond to various software applications, including image editing applications and design layout applications.

As further shown in FIG. 2, the UI-grounded action prediction system 106 generates a response to the query 210. In particular, the UI-grounded action prediction system 106 generates and provides instructions 212 within the panel 206 of the UI 202. As shown, the instructions 212 indicate a next action to perform (i.e., selecting the “segments” option in the panel 214) in performance of the task described by the query 210.

Indeed, in one or more embodiments, a task corresponds to a set of actions. In other words, in some embodiments, a task is performed via the performance of one or more actions. In one or more embodiments, an action includes a distinct act performed via a software application. In particular, in certain cases, an action includes a distinct act performed via user interaction with one or more interactive elements of a user interface of the software application.

Indeed, in some instances, an action includes at least an operation (e.g., an act performed) and a target interactive element (i.e., an interactive element targeted by the act). To illustrate, in some embodiments, an operation includes a click operation (e.g., including a hover operation or an operation for pressing enter), a type operation, or a select operation (e.g., an operation for selecting an option). In some instances, an operation uses an additional value for an argument of the operation. For instance, in some cases, a type operation or a select operation involves the entry or identification of one or more additional values as an argument indicating what is typed or what is selected, respectively. Notably, as shown in FIG. 2, the instructions 212 indicate that the next action for performing the task described by the query 210 involves an operation (e.g., selecting) and a target interactive element (e.g., the interactive element 208d associated with the “segments” option).

In some cases, a task corresponds to (e.g., is performed via) a sequence of actions. In one or more embodiments, a sequence of actions includes a plurality of actions having a particular order. Thus, in some cases, the next action indicated by the instructions 212 includes the next action in a sequence for performing the task indicated by the query 210. Additionally, as will be discussed below, in some cases, the UI-grounded action prediction system 106 determines that the sequence of actions for the task has already been begun. In other words, in some instances, the UI-grounded action prediction system 106 determines that one or more actions for the sequence of actions have been performed previously. Thus, in certain embodiments, the next action indicated by the instructions 212 includes the action in the sequence for the task that follows the one or more previous actions. Indeed, in certain embodiments, a previous action includes an action that has been performed previously. In particular, in some embodiments, a previous action includes an action that has been previously performed in performance of a task. More specifically, in certain implementations, a previous action includes an action that has already been performed for a current task (e.g., a task described in a query).

As shown in FIG. 2, the UI-grounded action prediction system 106 uses one or more large language models 216 in generating the instructions 212 in response to the query 210. For instance, in some embodiments, the UI-grounded action prediction system 106 uses a large language model to generate an estimated lookahead plan describing one or more actions for performing the task described by the query 210. Further, in certain cases, the UI-grounded action prediction system 106 uses one or more large language models to generate the next action using the estimated lookahead plan, such as by determining an operation and an interactive element of the UI 202 to target via the operation. In one or more embodiments, each of the one or more large language models 216 includes a neural network.

In one or more embodiments, a neural network includes a type of machine learning model, which are tunable (e.g., trainable) based on inputs to approximate unknown functions used for generating the corresponding outputs. In particular, in some embodiments, a neural network includes a model of interconnected artificial neurons (e.g., organized in layers) that communicate and learn to approximate complex functions and generate outputs based on inputs provided to the model. In some instances, a neural network includes one or more machine learning algorithms. Further, in some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial network, a graph neural network, a multi-layer perceptron, or a diffusion neural network. In some embodiments, a neural network includes a combination of neural networks or neural network components.

In one or more embodiments, a large language model includes a computer-implemented machine learning model trained to comprehend and generate human language text. In particular, in some embodiments, a large language model includes a neural network (e.g., a deep neural network) with many parameters trained on large quantities of data (e.g., unlabeled text) using a particular learning technique (e.g., self-supervised learning). For example, in some cases, a large language model includes a neural network having parameters trained to generate natural language text output from natural language text input. For instance, in certain instances, the UI-grounded action prediction system 106 uses a large language model to generate natural language text output that indicates a next action to execute in performance of a described task. Further, in some cases, the UI-grounded action prediction system 106 uses a large language model to generate natural language text output that describes an estimated lookahead plan for the task. In some embodiments, the UI-grounded action prediction system 106 uses in-context examples to enable a large language model to generate outputs using a particular format. In some cases, a large language model implements a deep transformer neural network architecture. Some examples of large language models include, but are not limited to, chat generative pre-trained transformer (Chat GPT), Gemini, Large Language Model Meta AI (LLaMA), and Flan-T5.

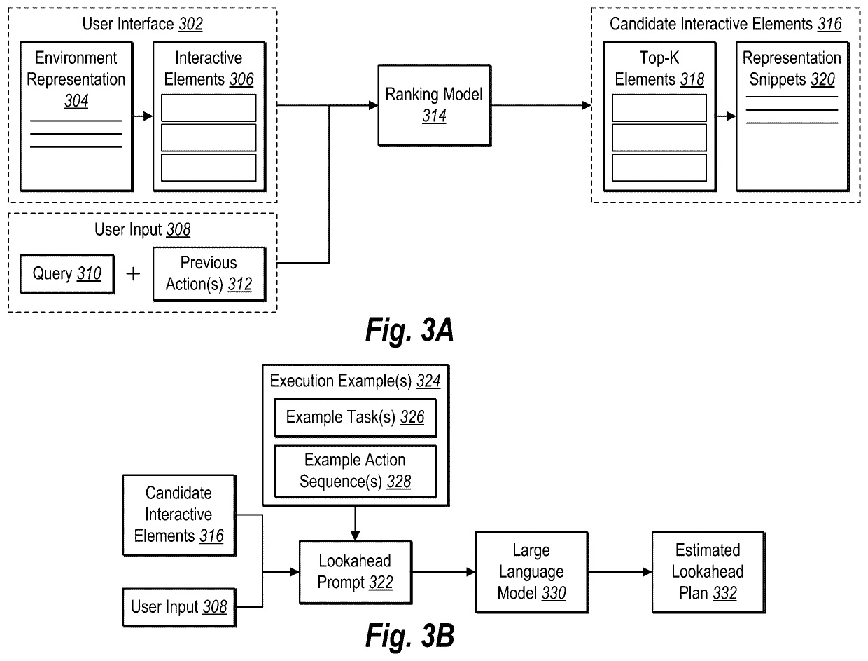

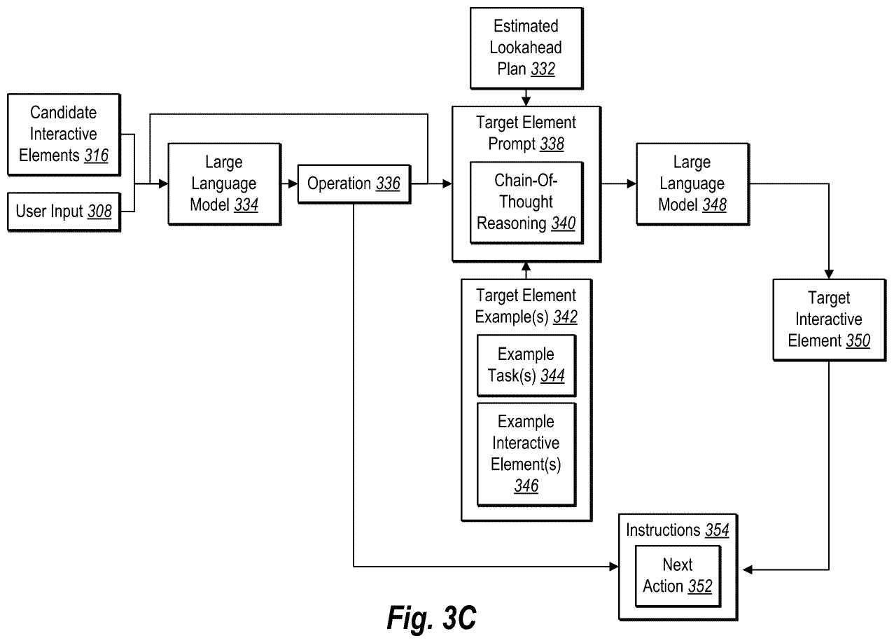

As mentioned, in one or more embodiments, the UI-grounded action prediction system 106 responds to a query by generating and providing instructions for performing a task via a user interface of a software application. In particular, the UI-grounded action prediction system 106 generates instructions for performing a next action in a sequence for performing the task. FIGS. 3A-3C illustrates the UI-grounded action prediction system 106 responding to a query by generating and providing instructions for performing a task via a user interface in accordance with one or more embodiments. In particular, FIG. 3A illustrates the UI-grounded action prediction system 106 performing a candidate generation step, and FIGS. 3B-3C illustrate the UI-grounded action prediction system 106 performing an action prediction step in accordance with one or more embodiments.

Indeed, FIG. 3A illustrates the UI-grounded action prediction system 106 determining a set of candidate interactive elements for use in determining a next action in accordance with one or more embodiments. In one or more embodiments, a candidate interactive element includes an interactive element of a UI that is considered for inclusion within instructions generated in response to a query for performing a task. In particular, in some cases, a candidate interactive element includes an interactive element of a UI that is relevant to the task. For instance, as will be discussed, in some embodiments, the UI-grounded action prediction system 106 identifies an interactive element as a candidate interactive element based on an indication that the interactive element is more closely related to the task than other interactive elements of the UI.

Indeed, as shown in FIG. 3A, the UI-grounded action prediction system 106 determines a plurality of interactive elements 306 of a UI 302, where the UI 302 includes the user interface of the software application being used. In other words, the UI 302 includes the user interface on which the task is to be performed. As shown, the UI-grounded action prediction system 106 determines (e.g., extracts) the plurality of interactive elements 306 from an environment representation 304 of the UI 302.

In one or more embodiments, an environment representation includes a representation of a UI. In particular, in some case, an environment representation includes a representation of the features and/or elements of a UI, including the interactive elements of the UI. For instance, in some instances, an environment representation includes a text description of the UI. In certain implementations, an environment representation includes a hypertext markup language (HTML) representation or other code-based representation of the UI. In some embodiments, an environment representation includes a representation derived from a text description, HTML representation, or other code-based representation of the UI.

Additionally, as FIG. 3A illustrates, the UI-grounded action prediction system 106 determines user input 308 received via the UI 302. In particular, the UI-grounded action prediction system 106 determines a query 310 for performing a task via the UI 302. In some cases, the query 310 includes natural language input received via the UI 302. In some instances, the query 310 includes keywords, or the UI-grounded action prediction system 106 extracts keywords from the query 310.

Further, as shown in FIG. 3A, the UI-grounded action prediction system 106 determines one or more previous actions 312 that have been executed in performance of the task described by the query 310. In particular, as previously mentioned, in some cases, the UI-grounded action prediction system 106 determines that the task has already been begun. In other words, the UI-grounded action prediction system 106 determines that, at the time of receiving the query 310 describing the task, one or more actions have already been performed for performing the task. Thus, in some cases, the UI-grounded action prediction system 106 tracks or otherwise monitors actions that have been performed via the UI 302 and, upon receiving the query 310, determines whether one or more of the previous actions (e.g., the most recent action(s)) correspond to the task.

As FIG. 3A illustrates, the UI-grounded action prediction system 106 uses a ranking model 314 to determine a set of candidate interactive elements 316 from the plurality of interactive elements 306. In particular, the UI-grounded action prediction system 106 uses the ranking model to analyze the plurality of interactive elements 306, the query 310, and the one or more previous actions 312, and determine the set of candidate interactive elements 316 based on the analysis.

In one or more embodiments, a ranking model includes a computer-implemented model that generates a ranking of a set of inputs. In particular, in some cases, a ranking model includes a computer-implemented model that generates a ranking for a plurality of interactive elements. In some cases, a ranking model includes a language model. For instance, in some embodiments, a ranking model includes an encoder-based language model, such as a cross-encoder or a bi-encoder.

As illustrated in FIG. 3A, the UI-grounded action prediction system 106 determines the set of candidate interactive elements 316 from the ranking generated by the ranking model 314 by determining the top-k interactive elements 318. For instance, in some cases, the UI-grounded action prediction system 106 determines the set of candidate interactive elements 316 as follows:

$${C}_{k} ( U ) = Retrieve ( g , U , {A}_{t - 1} ) \qquad ( 1 )$$

In equation 1, g represents the query 310 describing the task to be performed, U represents the environment representation 304 of the UI 302, and Aₜ₋₁ represents the one or more previous actions 312. Additionally, Retrieve represents the ranking model 314 used to produce the ranking of the plurality of interactive elements 306 of U. Thus, in some embodiments, the UI-grounded action prediction system 106 uses the ranking model 314 to rank the plurality of interactive elements 306 and determines the set of candidate interactive elements 316 (represented as Cₖ(U)) based on the ranking (e.g., by selecting the top-k interactive elements 318).

As shown in FIG. 3A, the UI-grounded action prediction system 106 determines representation snippets 320 associated with the top-k interactive elements 318. For instance, in some cases, the UI-grounded action prediction system 106 determines the portions of the environment representation 304 that correspond to the top-k interactive elements 318. To illustrate, where the environment representation 304 includes a HTML representation, the UI-grounded action prediction system 106 determines the portions of the HTML code that correspond to the top-k interactive elements 318.

FIG. 3B illustrates the UI-grounded action prediction system 106 performing lookahead plan generation for the action prediction step in accordance with one or more embodiments. Indeed, FIG. 3B illustrates the UI-grounded action prediction system 106 generating an estimated lookahead plan that describes one or more actions (e.g., the sequence of actions) for performing the task described by the query 310.

In one or more embodiments, an estimated lookahead plan includes a description of how a task is performed. In particular, in some embodiments, an estimated lookahead plan includes a description of the one or more actions (e.g., the sequence of actions) to execute in performance of the task. Indeed, in some cases, an estimated lookahead plan is an estimation in that it includes a description of the entirety of the task (e.g., including actions that come after the next action). In certain embodiments, as indicated in FIG. 3B, an estimated lookahead plan describes the remaining action(s) to execute in performance of the task. In other words, in certain cases, the UI-grounded action prediction system 106 determines that one or more previous actions have already been executed in performance of the task and generates the estimated lookahead plan to include the actions that follow the previous action(s) for the task. In certain implementations, an estimated lookahead plan includes a natural language description of the included action(s). In some cases, the estimated lookahead plan includes a summary description (e.g., an outline or bullet point listing of the included actions). In some embodiments, the estimated lookahead plan includes the operation of each action. In some instances, the estimated lookahead plan further includes the interactive element of each action.

As shown in FIG. 3B, the UI-grounded action prediction system 106 generates a lookahead prompt 322 from the user input 308 (e.g., the query 310 and the one or more previous actions 312) and the set of candidate interactive elements 316. Additionally, as shown, the UI-grounded action prediction system 106 generates the lookahead prompt 322 further from one or more execution examples 324.

In one or more embodiments, a lookahead prompt includes a prompt to generate an estimated lookahead plan. In particular, in some embodiments, a lookahead prompt includes a prompt used as input to a model prompting the model to generate an estimated lookahead plan. To illustrate, in some cases, a lookahead prompt includes a prompt used as input to a large language model prompting the large language model to generate an estimated lookahead plan. As indicated by FIG. 3B, in some cases, a lookahead prompt incorporates or is generated from user input (e.g., a query and/or one or more previous actions), a set of candidate interactive elements, and/or one or more execution examples. In some implementations, a lookahead prompt further incorporates or is generated from additional information, such as additional instructions or guidance (e.g., in the form of natural language). To illustrate, in certain implementations, a lookahead prompt describes the operations that are available to incorporate into the generated estimated lookahead plan (e.g., the operations that correspond to the set of candidate interactive elements). In some instances, a lookahead prompt also incorporates or is generated from an entity representation (e.g., an HTML representation) of the UI that is being used for performing the task and/or an indication of the UI or software application corresponding to the UI (e.g., a domain name, link, or web address to a website hosting the software application).

In one or more embodiments, an execution example includes an example plan for an example task. In particular, in some embodiments, an execution example includes an example action sequence for performing an example task on a UI of a software application. In some cases, an execution example includes an action sequence that has been previously executed in performance of a task on a UI of a software application. In some instances, an execution example includes a description of what actions would need to be executed via the UI (e.g., based on the UI design) in performing the task. In certain embodiments, an execution example includes an example task, an example action sequence for performing the example task, an indication of the UI or software application corresponding to the UI (e.g., a domain name, link, or web address to a website hosting the software application) associated with the example task (e.g., the UI of the software application used in performing the example task), and/or an environment representation of the UI. In some cases, an execution example includes an example action sequence by indicating the operation and/or interactive element for each action. In some instances, the UI-grounded action prediction system 106 uses execution examples to enable in-context learning for a large language model used in generating an estimated lookahead plan.

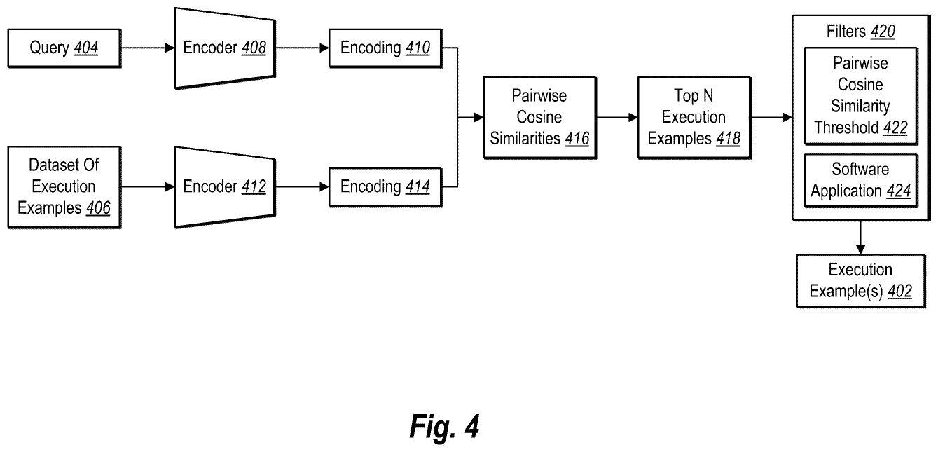

Indeed, as shown in FIG. 3B, the one or more execution examples 324 includes one or more example tasks 326 and one or more example action sequences 328. In particular, each execution example includes an example task and an example action sequence for performing the example task. Though not shown in FIG. 3B, in some cases, each execution example further includes an indication of the UI or software application corresponding to the UI associated with the example task and/or an environment representation of the UI. In certain embodiments, the UI-grounded action prediction system 106 retrieves the one or more execution examples 324 from a dataset of execution examples. Retrieving execution examples to use in generating an estimated lookahead plan will be discussed in more detail below with reference to FIG. 4.

As FIG. 3B shows, the UI-grounded action prediction system 106 provides the lookahead prompt 322 to a large language model 330. The UI-grounded action prediction system 106 uses the large language model 330 to generate an estimated lookahead plan 332 from the lookahead prompt. In some cases, the UI-grounded action prediction system 106 uses the large language model 330 to generate the estimated lookahead plan 332 as follows:

$$ℒ = {PlanGenerate}_{LLM} ( g , {C}_{k} ( U ) , {A}_{t - 1} , {T}_{n} ) \qquad ( 2 )$$

In equation 2, Tₙ represents the set of execution examples used for generating the estimated lookahead plan 332 (i.e., the one or more execution examples 324), PlanGenerate_{LLM} represents the large language model 330, and [symbol] represents the estimated lookahead plan 332. As mentioned, in some embodiments, the estimated lookahead plan 332 describes one or more actions (e.g., one or more remaining actions following the one or more previous actions 312 of the user input 308) for performing the task.

FIG. 3C illustrates the UI-grounded action prediction system 106 generating instructions to perform a next action for the action prediction step in accordance with one or more embodiments. Indeed, FIG. 3C illustrates the UI-grounded action prediction system 106 generating instructions indicating an operation and a target interactive element of the UI 302 to use in performing a next action for the task described by the query 310.

As shown in FIG. 3C, the UI-grounded action prediction system 106 uses a large language model 334 to generate an operation 336 from the set of candidate interactive elements 316 and the user input 308. In one or more embodiments, the large language model 334 includes the large language model 330 (or at least the same model architecture) used in generating the estimated lookahead plan 332. In some cases, however, the large language model 334 includes a different large language model (e.g., a different model architecture).

In one or more embodiments, the large language model 334 used to generate the operation 336 accepts a limited number of multi-choice inputs. In particular, in some cases, the large language model 334 accepts a limited number of candidate interactive elements to generate the operation 336. As such, in certain implementations, the UI-grounded action prediction system 106 splits the set of candidate interactive elements 316 into multiple subsets and performs multiple calls to the large language model 334 for the multiple subsets (e.g., one call per subset). In such embodiments, the UI-grounded action prediction system 106 further determines a majority vote on the output of the large language model 334 to determine the operation 336. To illustrate, in some cases, the UI-grounded action prediction system 106 determines the operation 336 (represented as τₜ) as follows:

$${τ}_{t} = MajorityVote ( {ActionGenerate}_{LLM} ( g , {C}_{k} ( U ) , {A}_{t - 1} ) ) \qquad ( 3 )$$

In equation 3, ActionGenerate_{LLM} represents the large language model 334 and MajorityVote represents determining the operation 336 based on a majority vote on the outputs of the large language model 334. As further shown in FIG. 3C, the UI-grounded action prediction system 106 uses the user input 308, the set of candidate interactive elements 316, the operation 336, and the estimated lookahead plan 332 to generate a target element prompt 338. Additionally, as shown, the UI-grounded action prediction system 106 uses one or more target element examples 342 to generate the target element prompt 338.

In one or more embodiments, a target element prompt includes a prompt to generate or determine a target interactive element. In particular, in some embodiments, a target element prompt includes a prompt used as input to a model prompting the model to generate or determine a target interactive element. To illustrate, in some cases, a lookahead prompt includes a prompt used as input to a large language model prompting the large language model to generate or determine a target interactive element for a next action for a task. As indicated by FIG. 3C, in some cases, a target element prompt incorporates or is generated from user input (e.g., a query and/or one or more previous actions), a set of candidate interactive elements, an operation, an estimated lookahead plan, and/or one or more target element examples. In some implementations, a target element prompt further incorporates or is generated from additional information, such as additional instructions or guidance (e.g., in the form of natural language). To illustrate, in certain implementations, a target element prompt describes the operations that are available (e.g., the operations that correspond to the set of candidate interactive elements). In some instances, a target element prompt also incorporates or is generated from an entity representation (e.g., an HTML representation) of the UI that is being used for performing the task and/or an indication of the UI or software application corresponding to the UI (e.g., a domain name, link, or web address to a website hosting the software application).

In one or more embodiments, a target element example includes an example target interactive element determined for an example task. In particular, in some embodiments, a target element example includes an example of selecting a target interactive element from a set (or subset) of candidate interactive elements for a next action for performing an example task on a UI of a software application. In some cases, a target element example includes a description of the selection of the target interactive element (e.g., a description of the selection process and/or the reasoning guiding the process). In certain embodiments, a target element example includes an example task, an example operation determined for the next action of the example task, an example interactive element selected for the next action of the example task, an indication of the UI or software application corresponding to the UI associated with the example task (e.g., the UI of the software application used in performing the example task), an environment representation of the UI, and/or an estimated lookahead plan that corresponds to the example task. In some instances, the UI-grounded action prediction system 106 uses execution examples to enable in-context learning for a large language model used in determining the target interactive element for the next action of the task.

Indeed, as shown in FIG. 3C, the one or more target element examples 342 includes one or more example tasks 344 and one or more example interactive elements 346. In particular, each target element example includes an example task and an example interactive element selected for the next action of the example task. Though not shown in FIG. 3C, in some cases, each target element example further includes an indication of the UI or software application corresponding to the UI associated with the example task and/or an environment representation of the UI. In certain embodiments, the UI-grounded action prediction system 106 retrieves the one or more target element examples 342 from a dataset of target element examples.

As shown in FIG. 3C, the target element prompt 338 includes chain-of-thought reasoning 340. In one or more embodiments, chain-of-thought reasoning includes reasoning related to the selection of a target interactive element for a next action of a task. In particular, in some embodiments, chain-of-thought reasoning includes a description of a thought process for selecting a target interactive element for a next action. In one or more embodiments, chain-of-thought reasoning breaks a larger thought process into multiple steps. To illustrate, in certain cases, chain-of-thought reasoning decomposes the selection of a target interactive element for a next action of a task into reasoning about a determined operation and choosing an appropriate interactive element that is compatible with the operation.

In one or more embodiments, the UI-grounded action prediction system 106 includes the chain-of-thought reasoning 340 via the one or more target element examples 342. In particular, in some cases, each target element example includes chain-of-thought reasoning describing the thought process that guided the selection of its example interactive element for the next action of its example task. Thus, in some cases, the UI-grounded action prediction system 106 uses the chain-of-thought reasoning 340 within the one or more target element examples 342 to condition a large language model to generate intermediate computations for a complex thought process.

Indeed, as shown in FIG. 3C, the UI-grounded action prediction system 106 provides the target element prompt 338 including the chain-of-thought reasoning 340 to a large language model 348. In some cases, the large language model 348 includes the large language model 330 (or at least the same model architecture) used in generating the estimated lookahead plan 332. In some instances, the large language model 348 includes the large language model 334 (or at least the same model architecture) used in determining the operation 336 for the next action. In some implementations, however, the large language model 348 includes a different large language model (e.g., a different model architecture).

As further shown in FIG. 3C, the UI-grounded action prediction system 106 uses the large language model 348 to generate or determine a target interactive element 350 for the next action of the task. To illustrate, in some embodiments, the UI-grounded action prediction system 106 uses the large language model 348 to determine the target interactive element 350 as follows:

$${a}_{t} = {ActionGenerate}_{LLM - CoT} ( g , {C}_{k} ( U ) , {A}_{t - 1} , {τ}_{t} , ℒ ) \qquad ( 4 )$$

In equation 4, ActionGenerate_{LLM-CoT} represents the large language model 348 incorporating the chain-of-thought reasoning 340 of the target element prompt 338. Though not explicitly shown in equation 4, in one or more embodiments, the UI-grounded action prediction system 106 also uses one or more target element examples in determining the target interactive element 350.

By determining the operation 336 and the target interactive element 350, the UI-grounded action prediction system 106 determines the next action 352 for the task described by the query 310. As shown in FIG. 3C, the UI-grounded action prediction system 106 generates instructions 354 for performing the next action 352. In some cases, the UI-grounded action prediction system 106 uses one of the large language model 334 or the large language model 348 to generate the instructions 354. For instance, in some cases, the UI-grounded action prediction system 106 uses the large language model 348 to generate the instructions 354 upon determining the target interactive element 350. By separately determining the operation 336 and the target interactive element 350 for the next action, one or more embodiments the UI-grounded action prediction system 106 incorporates cooperative reasoning into the action prediction process.

Thus, one or more embodiments of the UI-grounded action prediction system 106 use lookahead generation, chain-of-thought reasoning, and/or cooperative reasoning for the action prediction step. By incorporating one or more of these features into the action prediction step, certain embodiments of the UI-grounded action prediction system 106 improve upon the flexibility of conventional systems. In particular, one or more embodiments of the UI-grounded action prediction system 106 ground instructions in performing a next action for a task in the elements of the UI being used to perform the task, providing flexible adaptation to the current UI.

As the instructions are adapted to the UI being used, the instructions are more accurate when compared to those provided by conventional systems. In particular, the UI-grounded action prediction system 106 provides instructions that accurately incorporate an interactive element of the current UI. Researchers tested the performance of one or more embodiments of the UI-grounded action prediction system 106 with various baseline models, including the MindAct model described by X. Deng et al., Mind2Web: Towards a Generalist Agent for the Web, arXiv preprint arXiv:2306.06070, 2023. The embodiments of the UI-grounded action prediction system 106 outperformed the MindAct model at target element prediction by up to 16%. The embodiments of the UI-grounded action prediction system 106 further accurately grounded 50% of step-by-step answers to queries, outperforming the tested baseline models by 25%.

By providing more accurate instructions, the UI-grounded action prediction system 106 further provides improved efficiency in that the instructions enable user interactions to complete the task in a straight-forward manner. Indeed, by generating more accurate instructions, the UI-grounded action prediction system 106 reduces the excess user interactions that often occur under conventional systems that provide inaccurate or misleading instructions.

As previously mentioned, one or more embodiments of the UI-grounded action prediction system 106 use execution examples in generating an estimated lookahead plan for a task. In particular, in some cases, the UI-grounded action prediction system 106 incorporates one or more execution examples into a lookahead prompt provided to a large language model used to generate an estimated lookahead plan. FIG. 4 illustrates the UI-grounded action prediction system 106 selecting one or more execution examples for inclusion within a lookahead prompt in accordance with one or more embodiments.

As shown in FIG. 4, the UI-grounded action prediction system 106 determines one or more execution examples 402 to include within a lookahead prompt using a query 404 describing a task and a dataset 406 of execution examples. As shown, the UI-grounded action prediction system 106 uses an encoder 408 to generate an encoding 410 of the query 404. Further, the UI-grounded action prediction system 106 uses an encoder 412 to generate additional encodings 414 for a plurality of execution examples from the dataset 406 of execution examples. In one or more embodiments, the UI-grounded action prediction system 106 uses the same encoder for the encoder 408 and the encoder 412. In some cases, the UI-grounded action prediction system 106 uses separate encodings. In certain embodiments, the UI-grounded action prediction system 106 uses a bi-encoder for at least one of the encoder 408 or the encoder 412.

As further shown in FIG. 4, the UI-grounded action prediction system 106 determines pairwise cosine similarities 416 using the encoding 410 of the query 404 and the additional encodings 414 of the plurality of execution examples. In particular, in some cases, the UI-grounded action prediction system 106 determines a plurality of pairs, where each pair includes the encoding 410 of the query 404 and an additional encoding of an execution example. The UI-grounded action prediction system 106 further determines a pairwise cosine similarity for each pair.

Additionally, as illustrated, the UI-grounded action prediction system 106 determines the top n execution examples 418 based on the pairwise cosine similarities 416. In particular, the UI-grounded action prediction system 106 determines a ranking of the plurality of execution examples based on the pairwise cosine similarities 416. Using the ranking, the UI-grounded action prediction system 106 identifies the top n execution examples 418 having the highest associated pairwise cosine similarities. Indeed, in some cases, the UI-grounded action prediction system 106 determines that the top n execution examples 418 include example tasks that are most similar to the task described by the query 404 compared to other execution examples based on their associated pairwise cosine similarities.

As shown in FIG. 4, the UI-grounded action prediction system 106 filters the top n execution examples 418 using filters 420 to determine the one or more execution examples 402. Though multiple filters are shown in FIG. 4, various embodiments of the UI-grounded action prediction system 106 use one of the filters shown or filters in addition or as an alternative to those shown. FIG. 4 illustrates the UI-grounded action prediction system 106 using a pairwise cosine similarity threshold filter 422 and a software application filter 424.

In one or more embodiments, the UI-grounded action prediction system 106 uses the pairwise cosine similarity threshold filter 422 to filter out execution examples associated with a pairwise cosine similarity that fails to satisfy a pairwise cosine similarity threshold. In some cases, the UI-grounded action prediction system 106 uses the software application filter 424 to filter out execution examples that are associated with a software application that is different than the software application being used to perform the task. Thus, in some cases, upon filtering the top n execution examples 418 using the filters 420, the UI-grounded action prediction system 106 includes the remaining execution examples (e.g., the one or more execution examples 402) within the lookahead prompt that is provided to the large language model.

Though not shown in FIG. 4, in some cases, the UI-grounded action prediction system 106 further filters out the task described by the query 404 from the top n execution examples 418. For instance, in some cases, the UI-grounded action prediction system 106 uses training data as the dataset 406 of execution examples, and the training data includes the task described by the query 404. As such, in some cases, the UI-grounded action prediction system 106 determines that the query is included within the top n execution examples 418 based on its pairwise cosine similarity being relatively high and removes the query from the top n execution examples 418. In some instances, the UI-grounded action prediction system 106 removes the query before determining the pairwise cosine similarities 416 (e.g., when generating the additional encodings 414) to avoid consuming resources unnecessarily.

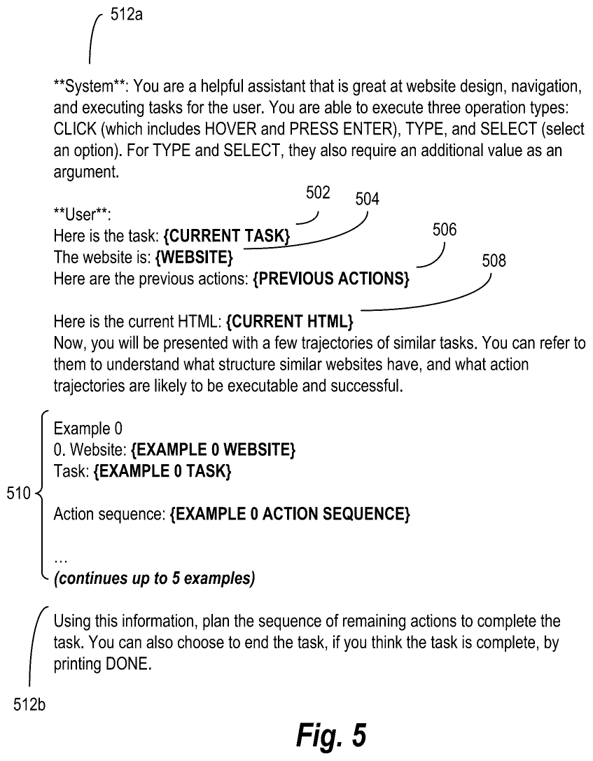

As previously discussed, in some cases, the UI-grounded action prediction system 106 uses a lookahead prompt to generate an estimated lookahead plan via a large language model. FIG. 5 illustrates a lookahead prompt in accordance with one or more embodiments.

As shown in FIG. 5, the lookahead prompt includes a description of a task 502. In particular, the task 502 includes the task described by the received query. Additionally, the lookahead prompt includes an indication 504 of the UI or software application corresponding to the UI that is being used to perform the task 502. Further, the lookahead prompt includes one or more previous actions 506 that have been executed in performance of the task 502 and an environment representation 508 of the UI being used.

Further, as shown, the lookahead prompt includes execution examples 510. For instance, in some cases, the lookahead prompt includes execution examples determined as described above with reference to FIG. 4. The lookahead prompt also includes additional information segments such as an information segment 512a indicating the available operations and an information segment 512b providing additional instruction for generating the estimated lookahead plan.

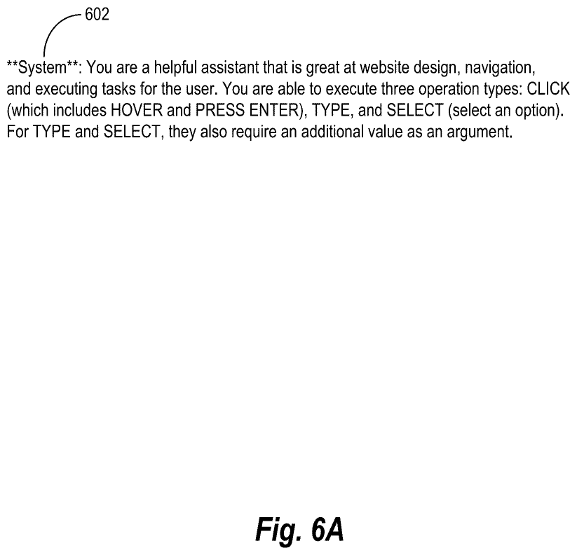

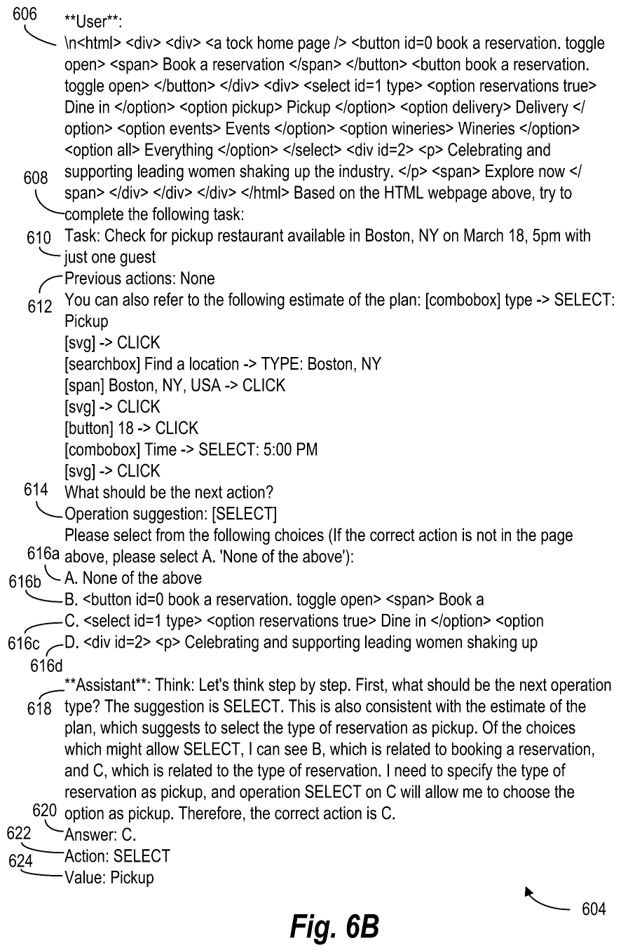

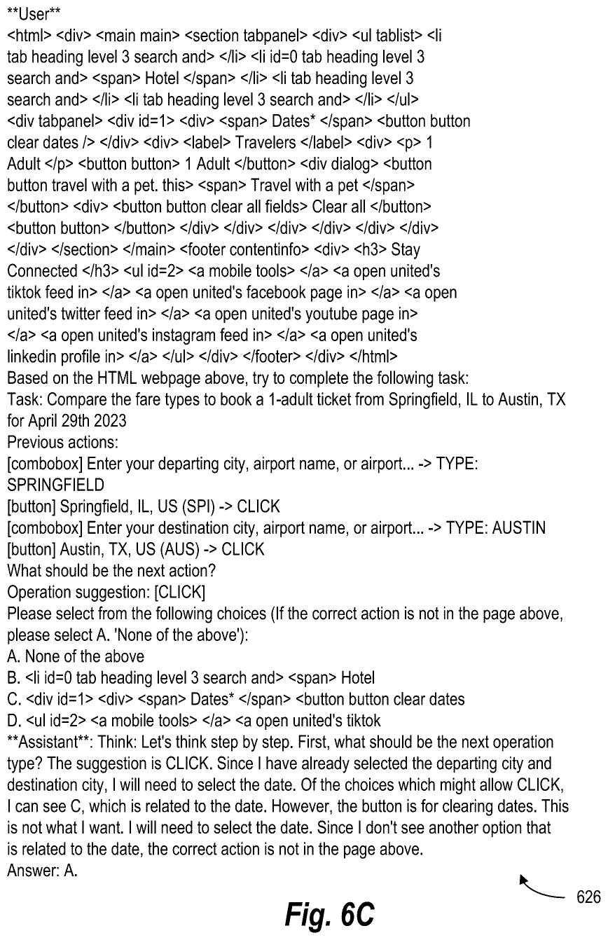

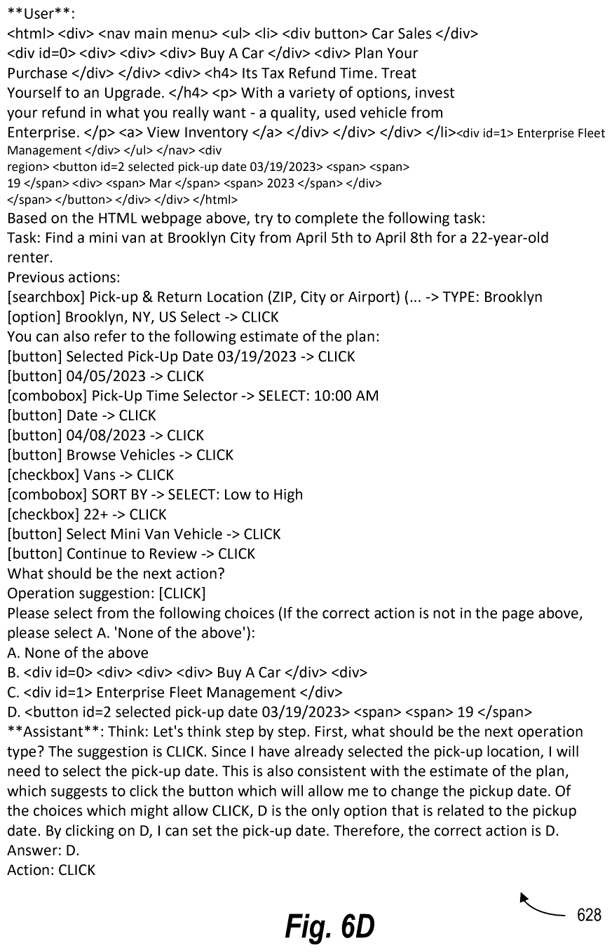

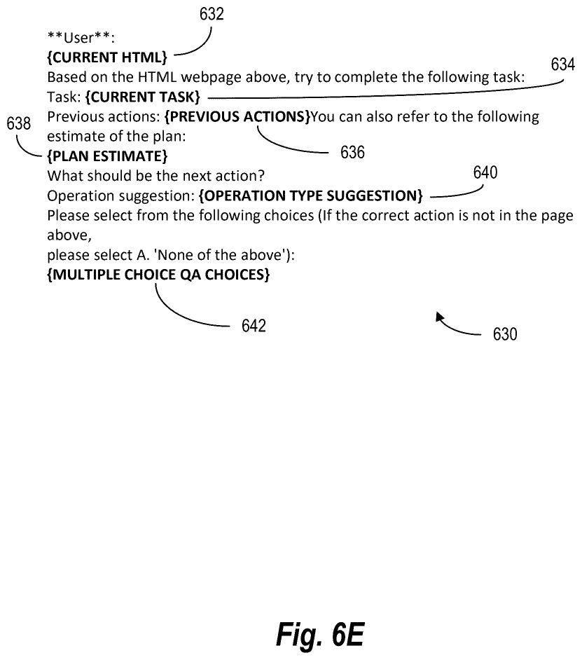

As further discussed, in some cases, the UI-grounded action prediction system 106 uses a target element prompt to determine an interactive element of the UI to be targeted in the next action for the task. FIGS. 6A-6E illustrate a target element prompt in accordance with one or more embodiments.

As shown in FIG. 6A, the target element prompt includes an information segment 602 that indicates the available operations for the next action. The information segment 602 further indicates that a subset of the available operations (e.g., the type operation and the select operation) require a value for use as an argument.

Additionally, as shown in FIGS. 6B, the target element prompt includes a first target element example 604. The first target element example 604 includes an environment representation 606 of the UI being used to perform the corresponding example task. The first target element example 604 further includes the example task 608 and previous actions 610 that have been executed for the example task 608 (indicating, here, that no previous actions have been performed). Additionally, the first target element example 604 includes an estimated lookahead plan 612 generated for the example task 608 and an example operation 614 that has been determined for the next action of the example task 608.

As further shown, the first target element example 604 includes options 616a-616d. Notably, the options 616b-616d correspond to candidate interactive elements, and option 616a indicates that the correct interactive element is not included within the candidate interactive elements of the options 616b-616d. As such, in some cases, the UI-grounded action prediction system 106 generates, via the large language model being used, output indicating that the correct interactive element is not found among the input candidates.

As shown, the first target element example 604 further includes an information segment 618 having chain-of-thought reasoning. In particular, the information segment 618 describes reasoning used by the large language model to process the input information and determine the example interactive element. For instance, as illustrated, the information segment 618 indicates that the example operation 614 determined for the next action of the example task 608 matches the next operation indicated by the estimated lookahead plan 612. The information segment 618 further describes the reasoning used in identifying a candidate interactive element from the options 616b-616d that is compatible with the example operation 614. The information segment 618 further describes the answer that results from this reasoning. Indeed, as shown, the first target element example 604 further includes the selected option 620 (e.g., the selected candidate interactive element), the determined operation 622 (which corresponds to the example operation 614), and the determined value 624 for the determined operation 622.

As shown in FIGS. 6C-6D, the target element prompt also includes a second target element example 626 and a third target element example 628. The number of target element examples varies in various implementations. In some cases, the UI-grounded action prediction system 106 includes a target element example based on the similarity of its example task to the current task to be performed. In certain embodiments, however, the UI-grounded action prediction system 106 includes a target element example regardless of its similarity to the current task.

As further shown in FIG. 6E, the target element prompt further includes inputs 630 for the current task. In particular, the target element prompt includes an environment representation 632 of the current UI being used for the task, the task 634 itself, previous actions 636 executed in performance of the task 634, an estimated lookahead plan 638 generated for the task 634, the determined operation 640, and a set of candidate interactive elements 642.

Turning now to FIG. 7, additional detail will now be provided regarding various components and capabilities of the UI-grounded action prediction system 106. In particular, FIG. 7 illustrates the UI-grounded action prediction system 106 implemented by the computing device 700 (e.g., the server device(s) 102 and/or one of the client devices 110a-110n discussed above with reference to FIG. 1). Additionally, the UI-grounded action prediction system 106 is part of the virtual assistant system 104. As shown in FIG. 7, the UI-grounded action prediction system 106 includes, but is not limited to, a user interface manager 702, a candidate generator 704, a lookahead generator 706, an action predictor 708, and data storage 710 (which includes a ranking model 712, large language models 714, execution examples 716, and target element examples 718).

As just mentioned, and as illustrated in FIG. 7, the UI-grounded action prediction system 106 includes the user interface manager 702. In one or more embodiments, the user interface manager 702 receives user input and provides output in response. For instance, in some cases, the user interface manager 702 receives a query for performing a task and provides instructions for performing a next action of the task in response.

Additionally, as shown in FIG. 7, the UI-grounded action prediction system 106 includes the candidate generator 704. In one or more embodiments, the candidate generator 704 determines a set of candidate interactive elements of the UI being used to perform the task for consideration when determining the next action. To illustrate, in some cases, the candidate generator 704 identifies a plurality of interactive elements of the UI, ranks the interactive elements via a ranking model, and determines a set of top-k interactive elements for consideration.

As further shown in FIG. 7, the UI-grounded action prediction system 106 includes the lookahead generator 706. In one or more embodiments, the lookahead generator 706 generates an estimated lookahead plan for a task described by a query. In particular, in some cases, the lookahead generator 706 uses a large language model to generate an estimated lookahead plan that describes the remaining actions for the task.

As shown in FIG. 7, the UI-grounded action prediction system 106 also includes the action predictor 708. In one or more embodiments, the action predictor 708 generates a next action in a sequence for performing a task via user interaction with an interactive element of the user interface currently being used. For example, in certain cases, the action predictor 708 uses one large language model to determine an operation for the next action and uses another large language model to determine an interactive element of the UI to be targeted via the operation. In some instances, the action predictor 708 determines the target interactive element from the set of candidate interactive elements. In some cases, the action predictor 708 further determines the target interactive element using an estimated lookahead plan generated for the task.

Further, as shown in FIG. 7, the UI-grounded action prediction system 106 includes data storage 710. In particular, data storage 710 includes ranking model 712, large language models 714, execution examples 716, and target element examples 718. In one or more embodiments, ranking model 712 includes the ranking model used to generate a ranking for the interactive elements of a UI in determining a set of candidate interactive elements. In some embodiments, large language models 714 includes the large language models used to determine the estimated lookahead plan, the operation, and the target interactive element for the task. In some cases, execution examples 716 includes a dataset of execution examples from which execution examples are selected for inclusion within a lookahead prompts. Additionally, in certain embodiments, target element examples 718 includes a dataset of target element examples from which target element examples are selected for inclusion within a target element prompt.

Each of the components 702-718 of the UI-grounded action prediction system 106 optionally include software, hardware, or both. For example, in some cases, the components 702-718 include one or more instructions stored on a computer-readable storage medium and executable by processors of one or more computing devices, such as a client device or server device. When executed by the one or more processors, the computer-executable instructions of one or more embodiments of the UI-grounded action prediction system 106 cause the computing device(s) to perform the methods described herein. Alternatively, in some instances, the components 702-718 include hardware, such as a special-purpose processing device to perform a certain function or group of functions. Alternatively, in certain implementations, the components 702-718 of the UI-grounded action prediction system 106 include a combination of computer-executable instructions and hardware.

Furthermore, in one or more embodiments, the components 702-718 of the UI-grounded action prediction system 106 are, for example, implemented as one or more operating systems, as one or more stand-alone applications, as one or more modules of an application, as one or more plug-ins, as one or more library functions or functions that are called by other applications, and/or as a cloud-computing model. Thus, in some embodiments, the components 702-718 of the UI-grounded action prediction system 106 are implemented as a stand-alone application, such as a desktop or mobile application. Furthermore, in some cases, the components 702-718 of the UI-grounded action prediction system 106 are implemented as one or more web-based applications hosted on a remote server. Alternatively, or additionally, the components 702-718 of the UI-grounded action prediction system 106 are implemented in a suite of mobile device applications or “apps.” For example, in one or more embodiments, the UI-grounded action prediction system 106 comprises or operates in connection with digital software applications such as ADOBE® PHOTOSHOP®, ADOBE® ILLUSTRATOR®, or ADOBE® ANALYTICS. The foregoing are either registered trademarks or trademarks of Adobe Inc. in the United States and/or other countries.

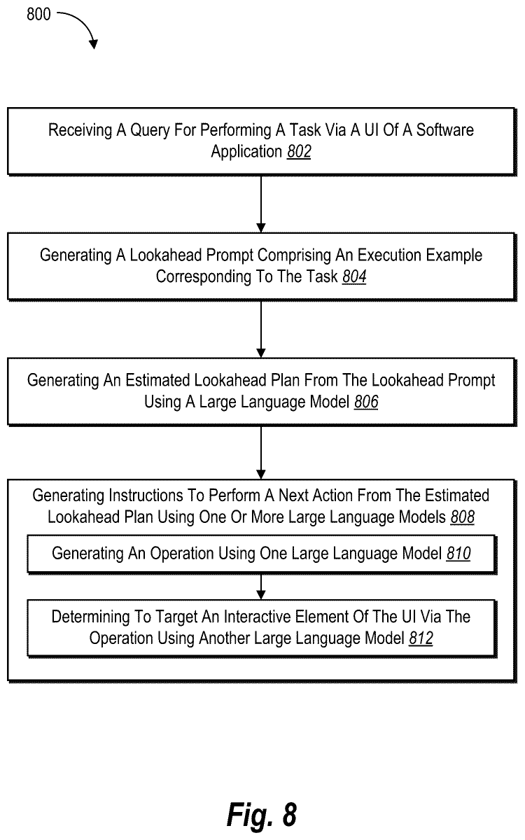

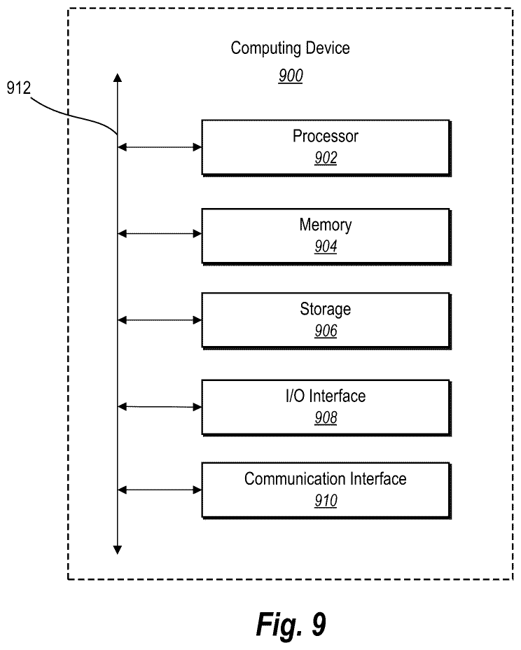

FIGS. 1-7, the corresponding text, and the examples provide a number of different methods, systems, devices, and non-transitory computer-readable media of the UI-grounded action prediction system 106. In addition to the foregoing, one or more embodiments are also described in terms of flowcharts comprising acts for accomplishing the particular result, as shown in FIG. 8. In one or more embodiments, FIG. 8 is performed with more or fewer acts. Further, in some embodiments, the acts are performed in different orders. Additionally, in some cases, the acts described herein are repeated or performed in parallel with one another or in parallel with different instances of the same or similar acts.

FIG. 8 illustrates a flowchart of a series of acts 800 for generating instructions for a performing a next action of a text described by a query in accordance with one or more embodiments. FIG. 8 illustrates acts according to one embodiment, but alternative embodiments omit, add to, reorder, and/or modify any of the acts shown in FIG. 8. In some implementations, the acts of FIG. 8 are performed as part of a computer-implemented method. Alternatively, in some embodiments, a non-transitory computer-readable medium stores executable instructions thereon that, when executed by a processing device, cause the processing device to perform operations comprising the acts of FIG. 8. In some embodiments, a system performs the acts of FIG. 8. For example, in some cases, a system includes one or more memory devices. The system further includes one or more processors configured to cause the system to perform the acts of FIG. 8.

The series of acts 800 includes an act 802 for receiving a query for performing a task via a UI of a software application. For example, in one or more embodiments, the act 802 involves receiving, from a client device interacting with a software application, a query for performing a task via a user interface of the software application.

The series of acts 800 also includes an act 804 for generating a lookahead prompt comprising an execution example corresponding to the task. For instance, in some embodiments, the act 804 involves generating a lookahead prompt comprising at least one execution example corresponding to the task, the at least one execution example including an example task and an example action sequence for performing the example task.

In one or more embodiments, the UI-grounded action prediction system 106 further generates, using an encoding model, an encoding of the query and a plurality of additional encodings for a plurality of execution examples from a dataset of execution examples; determines pairwise cosine similarities between the encoding of the query and the plurality of additional encodings; and selects the at least one execution example from the plurality of execution examples to include in the lookahead prompt based on the pairwise cosine similarities. In some cases, generating the plurality of additional encodings for the plurality of execution examples comprises generating the plurality of additional encodings for execution examples associated with a plurality of software applications; and selecting the at least one execution example to include in the lookahead prompt based on the pairwise cosine similarities comprises selecting the at least one execution example based on the pairwise cosine similarities and based on determining that the at least one execution example is associated with the software application.

Additionally, the series of acts 800 includes an act 806 for generating an estimated lookahead plan from the lookahead prompt using a large language model. To illustrate, in some cases, the act 806 involves generating, from the lookahead prompt using a large language model, an estimated lookahead plan describing one or more actions for performing the task.

In some implementations, the UI-grounded action prediction system 106 further determines a set of previous actions that have been executed in performance of the task. As such, in certain cases, generating the estimated lookahead plan describing the one or more actions for performing the task comprises generating the estimated lookahead plan describing one or more remaining actions to be executed after the set of previous actions in performing the task.

In some embodiments, the UI-grounded action prediction system 106 further determines an environment representation of the user interface. Accordingly, in some instances, generating the lookahead prompt comprising the at least one execution example corresponding to the task comprises generating the lookahead prompt comprising the at least one execution example and the environment representation. In certain cases, determining the environment representation of the user interface comprises determining a hypertext markup language representation of the user interface.

Further, the series of acts 800 includes an act 808 for generating instructions to perform a next action from the estimated lookahead plan using one or more large language models. For example, in certain instances, the act 808 involves generating, from the estimated lookahead plan using one or more large language models, instructions to perform a next action in a sequence for performing the task via user interaction with an interactive element of the user interface.

As shown in FIG. 8, the act 808 includes a sub-act 810 for generating an operation using one large language model. For instance, in one or more embodiments, generating, using the one or more large language models, the instructions to perform the next action in the sequence for performing the task comprises generating, using an additional large language model, an operation for the next action in the sequence for performing the task.

Additionally, as shown in FIG. 8, the act 808 also includes a sub-act 812 for determining to target an interactive element of the UI via the operation using another large language model. To illustrate, in some cases, generating, using the one or more large language models, the instructions to perform the next action in the sequence for performing the task comprises determining, using the large language model, to target the interactive element of the user interface via the operation of the next action. In some implementations, the UI-grounded action prediction system 106 further generates a target element prompt that includes chain-of-thought reasoning for selecting a target interactive element based on a determined operation. As such, in some cases, determining, using the large language model, to target the interactive element via the operation comprises determining, using the large language model, to target the interactive element via the operation by incorporating the chain-of-thought reasoning of the target element prompt via the large language model.

To provide an illustration, in one or more embodiments, the UI-grounded action prediction system 106 receives a query for performing a task via a user interface of a software application; determines a set of candidate interactive elements of the user interface of the software application that correspond to performance of the task; generates, from the set of candidate interactive elements using a first large language model, an estimated lookahead plan describing one or more actions for performing the task; generates, from the set of candidate interactive elements using a second large language model, an operation for a next action in a sequence for performing the task; and determines, from the set of candidate interactive elements and the estimated lookahead plan using the first large language model, an interactive element from the set of candidate interactive elements to target via the operation of the next action.

In some embodiments, the UI-grounded action prediction system 106 determines the set of candidate interactive elements of the user interface by: extracting, from an environment representation of the user interface, a plurality of interactive elements; generating, using a ranking model, a ranking of the plurality of interactive elements from the query and one or more previous actions that have been executed in performance of the task; and determining the set of candidate interactive elements from the plurality of interactive elements based on the ranking.

In some cases, the UI-grounded action prediction system 106 generates the estimated lookahead plan from the set of candidate interactive elements using the first large language model by: determining a set of execution examples corresponding to the task, each execution example including an example task and an example action sequence for performing the example task; generating pairwise cosine similarities between an encoding of the query and a plurality of additional encodings of the set of execution examples; and generating, using the first large language model, the estimated lookahead plan from the set of candidate interactive elements and one or more execution examples selected from the set of execution examples based on the pairwise cosine similarities. In some instances, the UI-grounded action prediction system 106 selects the one or more execution examples from the set of execution examples based on at least one of: determining that one or more pairwise cosine similarities determined for the one or more execution examples satisfy a pairwise cosine similarity threshold; or determining that the one or more pairwise cosine similarities determined for the one or more execution examples indicate a higher similarity to the query than remaining execution examples from the set of execution examples. In some implementations, the UI-grounded action prediction system 106 selects the one or more execution examples from the set of execution examples based on determining that the one or more execution examples are associated with the software application.

In one or more embodiments, the UI-grounded action prediction system 106 determines the interactive element from the set of candidate interactive elements and the estimated lookahead plan using the first large language model by: determining a set of target element examples, each target element example including an example task and an example interactive element determined to be targeted by an example operation in performance of an example next action for the example task; and determining, using the first large language model, the interactive element from the set of candidate interactive elements, the estimated lookahead plan, and the set of target element examples. In some embodiments, determining, using the first large language model, the interactive element from the set of candidate interactive elements, the estimated lookahead plan, and the set of target element examples comprises: generating a target element prompt that includes chain-of-thought reasoning for selecting a target interactive element based on a determined operation and incorporates the set of candidate interactive elements, the estimated lookahead plan, and the set of target element examples; and determining, using the first large language model, the interactive element from the target element prompt.

In certain implementations, the UI-grounded action prediction system 106 generates the operation for the next action in the sequence for performing the task by determining that the operation includes a type operation or a select operation; and determines a value as an argument for the type operation or the select operation.

To provide another illustration, in one or more embodiments, the UI-grounded action prediction system 106 receives, from a client device interacting with a software application, a query for performing a task via a user interface of the software application; determines an environment representation of the user interface and one or more previous actions that have been executed in performance of the task; generates, using a large language model, an estimated lookahead plan describing one or more remaining actions for performing the task from the environment representation, the one or more previous actions, and an execution example including an example task and an example action sequence for performing the example task; and generates, from the estimated lookahead plan using one or more large language models, instructions to perform a next action for performing the task via user interaction with an interactive element of the user interface.

In some cases, generating, from the estimated lookahead plan using the one or more large language models, the instructions to perform the next action comprises generating, from a next operation indicated by the estimated lookahead plan using the one or more large language models, the instructions to perform the next action. In some instances, generating, from the next operation indicated by the estimated lookahead plan using the one or more large language models, the instructions to perform the next action comprises: generating, using an additional large language model, an operation for the next action; and generating the instructions to include the operation as part of the next action based on comparing the operation generated via the additional large language model to the next operation indicated by the estimated lookahead plan.

Some embodiments of the present disclosure comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, in some cases, one or more of the processes described herein are implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

In one or more embodiments, computer-readable media include various available media that is accessible by a general purpose or special purpose computer system. Computer-readable media that store computer-executable instructions are non-transitory computer-readable storage media (devices). Computer-readable media that carry computer-executable instructions are transmission media. Thus, by way of example, and not limitation, one or more embodiments of the disclosure comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which is usable to store desired program code means in the form of computer-executable instructions or data structures and which is accessible by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. In some cases, transmissions media includes a network and/or data links which are usable to carry desired program code means in the form of computer-executable instructions or data structures and which is accessible by a general purpose or special purpose computer. Combinations of the above should also be included within the scope of computer-readable media.

Further, upon reaching various computer system components, program code means in the form of computer-executable instructions or data structures is transferrable automatically from transmission media to non-transitory computer-readable storage media (devices) (or vice versa). For example, in some cases, computer-executable instructions or data structures received over a network or data link are buffered in RAM within a network interface module (e.g., a “NIC”), and then eventually transferred to computer system RAM and/or to less volatile computer storage media (devices) at a computer system. Thus, it should be understood that, in some cases, non-transitory computer-readable storage media (devices) are included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. In some instances, the computer executable instructions are, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that one or more embodiments are practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. Some implementations are practiced in distributed system environments where local and remote computer systems, which are linked (either by hardwired data links, wireless data links, or by a combination of hardwired and wireless data links) through a network, both perform tasks. In some implementations, in a distributed system environment, program modules are located in both local and remote memory storage devices.

Some embodiments of the present disclosure are implemented in cloud computing environments. In this description, “cloud computing” is defined as a model for enabling on-demand network access to a shared pool of configurable computing resources. For example, in some cases, cloud computing is employed in the marketplace to offer ubiquitous and convenient on-demand access to the shared pool of configurable computing resources. In some instances, the shared pool of configurable computing resources is rapidly provisioned via virtualization and released with low management effort or service provider interaction, and then scaled accordingly.

In one or more embodiments, a cloud-computing model is composed of various characteristics such as, for example, on-demand self-service, broad network access, resource pooling, rapid elasticity, measured service, and so forth. In some embodiments, a cloud-computing model exposes various service models, such as, for example, Software as a Service (“SaaS”), Platform as a Service (“PaaS”), and Infrastructure as a Service (“IaaS”). In some instances, a cloud-computing model is deployed using different deployment models such as private cloud, community cloud, public cloud, hybrid cloud, and so forth. In this description and in the claims, a “cloud-computing environment” is an environment in which cloud computing is employed.

FIG. 9 illustrates a block diagram of an example computing device 900 that is configured to perform one or more of the processes described above in some embodiments. One will appreciate that one or more computing devices, such as the computing device 900, represent the computing devices described above (e.g., the server device(s) 102 and/or the client devices 110a-110n) in some implementations. In one or more embodiments, the computing device 900 is a mobile device (e.g., a mobile telephone, a smartphone, a PDA, a tablet, a laptop, a camera, a tracker, a watch, a wearable device). In some embodiments, the computing device 900 is a non-mobile device (e.g., a desktop computer or another type of client device). Further, in certain embodiments, the computing device 900 is a server device that includes cloud-based processing and storage capabilities.

As shown in FIG. 9, the computing device 900 includes one or more processor(s) 902, memory 904, a storage device 906, input/output interfaces 908 (or “I/O interfaces 908”), and a communication interface 910, which are communicatively coupled by way of a communication infrastructure (e.g., bus 912). While the computing device 900 is shown in FIG. 9, the components illustrated in FIG. 9 are not intended to be limiting. Additional or alternative components are used in other embodiments. Furthermore, in certain embodiments, the computing device 900 includes fewer components than those shown in FIG. 9. Components of the computing device 900 shown in FIG. 9 will now be described in additional detail.

In particular embodiments, the processor(s) 902 includes hardware for executing instructions, such as those making up a computer program. As an example, and not by way of limitation, to execute instructions, the processor(s) 902 retrieve (or fetch) the instructions from an internal register, an internal cache, memory 904, or a storage device 906 and decode and execute them in some implementations.

The computing device 900 includes memory 904, which is coupled to the processor(s) 902. In certain cases, the memory 904 is used for storing data, metadata, and programs for execution by the processor(s). In some instances, the memory 904 includes one or more of volatile and non-volatile memories, such as Random-Access Memory (“RAM”), Read-Only Memory (“ROM”), a solid-state disk (“SSD”), Flash, Phase Change Memory (“PCM”), or other types of data storage. In some embodiments, the memory 904 includes internal or distributed memory.

The computing device 900 includes a storage device 906 including storage for storing data or instructions. As an example, and not by way of limitation, in some cases, the storage device 906 includes a non-transitory storage medium described above. In some embodiments, the storage device 906 includes a hard disk drive (HDD), flash memory, a Universal Serial Bus (USB) drive or a combination these or other storage devices.

As shown, the computing device 900 includes one or more I/O interfaces 908, which are provided to allow a user to provide input to (such as user strokes), receive output from, and otherwise transfer data to and from the computing device 900. In one or more embodiments, these I/O interfaces 908 include a mouse, keypad or a keyboard, a touch screen, camera, optical scanner, network interface, modem, other known I/O devices or a combination of such I/O interfaces 908. In some cases, the touch screen is activated with a stylus or a finger.

In one or more embodiments, the I/O interfaces 908 include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 908 are configured to provide graphical data to a display for presentation to a user. In some cases, the graphical data is representative of one or more graphical user interfaces and/or any other graphical content that serves a particular implementation.

The computing device 900 further includes a communication interface 910. In some cases, the communication interface 910 includes hardware, software, or both. The communication interface 910 provides one or more interfaces for communication (such as, for example, packet-based communication) between the computing device and one or more other computing devices or one or more networks. As an example, and not by way of limitation, in some cases, communication interface 910 includes a network interface controller (NIC) or network adapter for communicating with an Ethernet or other wire-based network or a wireless NIC (WNIC) or wireless adapter for communicating with a wireless network, such as a WI-FI. The computing device 900 further includes a bus 912. In some cases, the bus 912 includes hardware, software, or both that connects components of computing device 900 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

Various implementations of the present invention are embodied in other specific forms without departing from its spirit or essential characteristics. The described embodiments are to be considered in all respects only as illustrative and not restrictive. For example, in some embodiments, the methods described herein are performed with less or more steps/acts or the steps/acts are performed in differing orders. Additionally, in some cases, the steps/acts described herein are repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving, from a client device interacting with a software application, a query for performing a task via a user interface of the software application;
generating a lookahead prompt comprising at least one execution example corresponding to the task, the at least one execution example including an example task and an example action sequence for performing the example task;
generating, from the lookahead prompt using a large language model, an estimated lookahead plan describing one or more actions for performing the task; and
generating, from the estimated lookahead plan using one or more large language models, instructions to perform a next action in a sequence for performing the task via user interaction with an interactive element of the user interface.

2. The computer-implemented method of claim 1, wherein generating, using the one or more large language models, the instructions to perform the next action in the sequence for performing the task comprises generating, using an additional large language model, an operation for the next action in the sequence for performing the task.

3. The computer-implemented method of claim 2, wherein generating, using the one or more large language models, the instructions to perform the next action in the sequence for performing the task comprises determining, using the large language model, to target the interactive element of the user interface via the operation of the next action.

4. The computer-implemented method of claim 3,
further comprising generating a target element prompt that includes chain-of-thought reasoning for selecting a target interactive element based on a determined operation;
wherein determining, using the large language model, to target the interactive element via the operation comprises determining, using the large language model, to target the interactive element via the operation by incorporating the chain-of-thought reasoning of the target element prompt via the large language model.

5. The computer-implemented method of claim 1, further comprising:
generating, using an encoding model, an encoding of the query and a plurality of additional encodings for a plurality of execution examples from a dataset of execution examples;
determining pairwise cosine similarities between the encoding of the query and the plurality of additional encodings; and
selecting the at least one execution example from the plurality of execution examples to include in the lookahead prompt based on the pairwise cosine similarities.

6. The computer-implemented method of claim 5, wherein:
generating the plurality of additional encodings for the plurality of execution examples comprises generating the plurality of additional encodings for execution examples associated with a plurality of software applications; and
selecting the at least one execution example to include in the lookahead prompt based on the pairwise cosine similarities comprises selecting the at least one execution example based on the pairwise cosine similarities and based on determining that the at least one execution example is associated with the software application.

7. The computer-implemented method of claim 1,
further comprising determining a set of previous actions that have been executed in performance of the task,
wherein generating the estimated lookahead plan describing the one or more actions for performing the task comprises generating the estimated lookahead plan describing one or more remaining actions to be executed after the set of previous actions in performing the task.

8. The computer-implemented method of claim 1,
further comprising determining an environment representation of the user interface,
wherein generating the lookahead prompt comprising the at least one execution example corresponding to the task comprises generating the lookahead prompt comprising the at least one execution example and the environment representation.

9. The computer-implemented method of claim 8, wherein determining the environment representation of the user interface comprises determining a hypertext markup language representation of the user interface.

10. A system comprising:
one or more memory devices; and
one or more processors configured to cause the system to:
receive a query for performing a task via a user interface of a software application;
determine a set of candidate interactive elements of the user interface of the software application that correspond to performance of the task;
generate, from the set of candidate interactive elements using a first large language model, an estimated lookahead plan describing one or more actions for performing the task;
generate, from the set of candidate interactive elements using a second large language model, an operation for a next action in a sequence for performing the task; and
determine, from the set of candidate interactive elements and the estimated lookahead plan using the first large language model, an interactive element from the set of candidate interactive elements to target via the operation of the next action.

11. The system of claim 10, wherein the one or more processors are configured to cause the system to determine the set of candidate interactive elements of the user interface by:
extracting, from an environment representation of the user interface, a plurality of interactive elements;
generating, using a ranking model, a ranking of the plurality of interactive elements from the query and one or more previous actions that have been executed in performance of the task; and
determining the set of candidate interactive elements from the plurality of interactive elements based on the ranking.

12. The system of claim 10, wherein the one or more processors are configured to cause the system to generate the estimated lookahead plan from the set of candidate interactive elements using the first large language model by:
determining a set of execution examples corresponding to the task, each execution example including an example task and an example action sequence for performing the example task;
generating pairwise cosine similarities between an encoding of the query and a plurality of additional encodings of the set of execution examples; and
generating, using the first large language model, the estimated lookahead plan from the set of candidate interactive elements and one or more execution examples selected from the set of execution examples based on the pairwise cosine similarities.

13. The system of claim 12, wherein the one or more processors are further configured to cause the system to select the one or more execution examples from the set of execution examples based on at least one of:
determining that one or more pairwise cosine similarities determined for the one or more execution examples satisfy a pairwise cosine similarity threshold; or
determining that the one or more pairwise cosine similarities determined for the one or more execution examples indicate a higher similarity to the query than remaining execution examples from the set of execution examples.

14. The system of claim 13, wherein the one or more processors are further configured to cause the system to select the one or more execution examples from the set of execution examples based on determining that the one or more execution examples are associated with the software application.

15. The system of claim 10, wherein the one or more processors are configured to cause the system to determine the interactive element from the set of candidate interactive elements and the estimated lookahead plan using the first large language model by:
determining a set of target element examples, each target element example including an example task and an example interactive element determined to be targeted by an example operation in performance of an example next action for the example task; and
determining, using the first large language model, the interactive element from the set of candidate interactive elements, the estimated lookahead plan, and the set of target element examples.

16. The system of claim 15, wherein determining, using the first large language model, the interactive element from the set of candidate interactive elements, the estimated lookahead plan, and the set of target element examples comprises:
generating a target element prompt that includes chain-of-thought reasoning for selecting a target interactive element based on a determined operation and incorporates the set of candidate interactive elements, the estimated lookahead plan, and the set of target element examples; and
determining, using the first large language model, the interactive element from the target element prompt.

17. The system of claim 10, wherein the one or more processors are further configured to cause the system to:
generate the operation for the next action in the sequence for performing the task by determining that the operation includes a type operation or a select operation; and
determine a value as an argument for the type operation or the select operation.

18. A non-transitory computer-readable medium storing executable instructions which, when executed by a processing device, cause the processing device to perform operations comprising:
receiving, from a client device interacting with a software application, a query for performing a task via a user interface of the software application;
determining an environment representation of the user interface and one or more previous actions that have been executed in performance of the task;
generating, using a large language model, an estimated lookahead plan describing one or more remaining actions for performing the task from the environment representation, the one or more previous actions, and an execution example including an example task and an example action sequence for performing the example task; and
generating, from the estimated lookahead plan using one or more large language models, instructions to perform a next action for performing the task via user interaction with an interactive element of the user interface.

19. The non-transitory computer-readable medium of claim 18, wherein generating, from the estimated lookahead plan using the one or more large language models, the instructions to perform the next action comprises generating, from a next operation indicated by the estimated lookahead plan using the one or more large language models, the instructions to perform the next action.

20. The non-transitory computer-readable medium of claim 19, wherein generating, from the next operation indicated by the estimated lookahead plan using the one or more large language models, the instructions to perform the next action comprises:
generating, using an additional large language model, an operation for the next action; and
generating the instructions to include the operation as part of the next action based on comparing the operation generated via the additional large language model to the next operation indicated by the estimated lookahead plan.
